(19) United States
(12) Patent Application Publication
(10) Pub. No.: US 2025/0246916 A1
(43) Pub. Date: Jul. 31, 2025

(54) POWER FEEDER, CONVERSION ADAPTER, AND POWER FEEDING APPARATUS

(71) Applicant: ELECOM CO., LTD., Osaka (JP)

(72) Inventors: Noriaki IIDA, Osaka (JP); Kazuki IZUMIZAWA, Osaka (JP); Shinya SAWAI, Osaka (JP); Shigeru MIYAJIMA, Osaka (JP); Huide GUO, Osaka (JP); Yasuhiro YAMAMOTO, Osaka (JP)

(21) Appl. No.: 19/014,388

(22) Filed: Jan. 9, 2025

(30) Foreign Application Priority Data
Jan. 10, 2024 (JP) 2024-001873

(51) Int. Cl. H02J 7/00

(52) U.S. Cl. CPC H02J 7/00045; H02J 7/00034; H02J 7/0044; H02J 2207/30

(57) ABSTRACT

A power feeding apparatus 100, compatible with the DC power input terminal of the information communication device and capable of supplying the DC power required by the information communication device, is constituted of: a power feeder 10 including a power plug unit 11 to which AC power is inputted, an AC/DC conversion circuit 12 that converts AC power into DC power, and a DC output unit (a USB port unit 13) that outputs the converted power; and a conversion adapter 20 equipped with a jack 25 shaped to fit a DC power input unit of a specific personal computer, wherein the power feeder 10 detects a type of the conversion adapter 20 and outputs DC power corresponding to the conversion adapter 20.

### BACKGROUND OF THE INVENTION

### Field of the Invention

The present invention relates to a power feeder, a conversion adapter, and a power feeding apparatus used to feed power to an information communication device such as a notebook computer.

### Description of the Related Art

For example, the following inventions are disclosed regarding a connection between a power feeder and an electronic device such as a notebook computer.

For example, Patent Literature 1 (Japanese Patent Laid-Open No. 2019-109898) discloses a method, an electronic device, and a charger apparatus for USB charging that reduce charging time while reducing charging/feeding level mismatch and product damage without requiring user action.

In the charging system described in Patent Literature 1, the electronic device and a USB charger use a USB cable data line to establish a two-way communication connection. The USB charger provides charger capability information to a master controller of the electronic device via the two-way communication connection. The master controller preferentially selects a fastest charging match between the charger capability information and device charging capability information and transmits configuration information via the two-way communication connection to set a power supply level of the USB charger. The USB charger communicates power supply status information to the electronic device and, accordingly, the electronic device reconfigures the power supply level of the charger.

Patent Literature 2 (Japanese Patent Laid-Open No. 2022-117702) discloses a portable charger with enhanced user convenience regarding work at the start of charging.

The portable charger described in Patent Literature 2 is equipped with a power plug unit, a DC output unit, a power conversion circuit, and a control apparatus. The power plug unit is configured to be connectable to an output unit of power feeding equipment and AC power is inputted from the output unit of the power feeding equipment. The DC output unit is configured to be connectable to a power receiving unit of an object to which power is to be fed and outputs DC power to the power receiving unit of the object to which power is to be fed. The power conversion circuit is configured to convert AC power inputted from the power plug unit into DC power and output the DC power to the DC output unit.

The control apparatus controls the power conversion circuit. The DC output unit has a start switch. When operated by a user, the start switch instructs the control apparatus to control the power conversion circuit so that the DC output unit outputs DC power. However, when at least one of the power plug unit and the DC output unit is not connected, the start switch is disabled.

Patent Literature 3 (Japanese Translation of PCT International Application Publication No. 2017-521777) discloses an apparatus and a method for distinguishing among a dedicated charger, a non-floating charger, and a floating charger for regulating a charging current.

A portable device described in Patent Literature 3 is provided with a charger detection circuit. The charger detection circuit is configured to detect whether a connected universal serial bus (USB) charger complies with the USB battery charging specification. The charger detection circuit is configured to further detect, when the connected USB charger does not comply with the battery charging specification, whether the non-compliant USB charger is a non-compliant floating charger or a non-compliant dedicated charger. The portable electronic device can be configured to draw up to a maximum charging current according to the USB battery charging specification when the connected USB charger is determined to be a non-compliant dedicated USB charger.

Patent Literature 4 (Japanese Translation of PCT International Application Publication No. 2016-531368) discloses a method of changing a default current limit value of a USB power system.

An electronic system described in Patent Literature 4 can include a cable detector component to detect a plug coupled to a port, a source detector component to determine an identification of a power source, and a circuit configuration to modify an input current limit value or an output current limit value of an electronic device.

### CITATION LIST

### Patent Literature

Patent Literature 1: Japanese Patent Laid-Open No. 2019-109898
Patent Literature 2: Japanese Patent Laid-Open No. 2022-117702
Patent Literature 3: Japanese Translation of PCT International Application Publication No. 2017-521777
Patent Literature 4: Japanese Translation of PCT International Application Publication No. 2016-531368

### SUMMARY OF INVENTION

### Technical Problem

Recently, USB-PD (USB Power Delivery) was established as a standard for USB-Type-C charging and, when combining a USB-PD compatible charger, a USB-C cable, and an information communication device such as a notebook computer that supports USB-PD, power up to 100 W or 240 W (USB-PD 3.1) can be supplied.

Furthermore, in USB-PD 3.0 and later, a PPS (Programmable Power Supply) function has been added as an option to promote optimal charging, allowing voltage and current outputted by the charger to be finely set with respect to PPS-compatible information communication devices.

However, in reality, there are a large number of information communication devices that either do not support USB-PD or do not have PPS functionality and the number of such devices is not expected to rapidly become smaller in the future. In particular, in notebook computers, a terminal shape, a required input voltage, and a current of DC power input units differ from model to model or manufacturer to manufacturer.

The differences in the terminal shapes of the DC power input units can be accommodated by providing an output jack with a different shape for each notebook computer. However, as for differences in required input voltage and current, it is difficult to provide a charger that is compatible with each notebook computer. As a result, for example, a 20 V-output charger is used to charge a 19 V-input notebook computer, causing significant power loss and heat generation from the charger and/or notebook computer and, in some cases, even resulting in damage or the like.

In the charging system described in Patent Literature 1, the electronic device and the charger apparatus can exchange charger capability information and device charging capability information via the USB cable to reconfigure an optimal power supply level of the charger.

However, when charging a notebook computer that does not support USB-PD, particularly a notebook computer with a unique DC power input terminal, although a shape of an output jack of the conversion adapter can be adapted to a shape of the notebook computer, information on the device charging capability required by the notebook computer cannot be provided to the charger, and therefore, the output voltage and current on the charger side cannot be optimized, and problems of power loss, heat generation and/or damage cannot be solved.

While a feature of the portable charger described in Patent Literature 2 is that the start switch is provided in the DC output unit and the start switch is disabled when at least one of the power plug unit and the DC output unit is not connected, the charger is not equipped with a function to detect a voltage or current required by the electronic device to which the charger is connected and a function to adjust a voltage or current of the DC output unit to the voltage or current required by the electronic device to which the charger is connected.

The portable device described in Patent Literature 3 is provided with a charger detection circuit and can be configured to detect a specification of a connected USB charger and draw up to a maximum charging current according to the USB battery charging specification when the connected USB charger is determined to be a non-compliant dedicated USB charger.

However, in the case of a conventional notebook computer with a unique DC power input terminal, since information on the device charging capability required by the notebook computer cannot be provided to the charger, the output voltage and current on the charger side cannot be optimized.

The electronic system described in Patent Literature 4 is capable of modifying a default current limit value due to being equipped with the cable detector component, the source detector component, and the circuit configuration to modify an input current limit value or an output current limit value of an electronic device.

However, even in this case, since there is no path to modify the current limit value of the charger from the side of a notebook computer with a unique DC power input terminal, the output current on the charger side cannot be optimized.

A primary object of the present invention is to provide, with respect to an information communication device such as a notebook computer equipped with a unique DC power input terminal, a power feeding apparatus that is compatible with the DC power input terminal of the information communication device and capable of supplying the DC power required by the information communication device, and a power feeder and a conversion adapter constituting the power feeding apparatus.

Another object of the present invention is to provide a power feeding apparatus capable of protecting the power feeding apparatus and an information communication device by stopping output of the power feeding apparatus when the power feeding apparatus is unable to supply DC power required by the information communication device, and a power feeder and a conversion adapter constituting the power feeding apparatus.

### SUMMARY OF THE INVENTION

(1)

A power feeder according to one aspect includes: a power plug unit to which AC power is inputted; an AC/DC conversion circuit that converts AC power into DC power; a DC output unit that outputs the converted power; and a detecting unit that detects, when a conversion adapter equipped with a jack shaped to fit a DC power input unit of a specific personal computer is connected to the DC output unit, a type of the conversion adapter.

Conventionally, with information communication devices such as notebook computers, power feeders with a specifically-shaped jack and specific DC voltage and current output specifications were provided as accessories or options to be used when using the information communication devices. However, the power feeders were sometimes difficult to use due to their large overall size and the like.

On the other hand, with small information communication devices such as smartphones, USB power feeders that are small and can be plugged directly into household AC power outlets have been widely used.

Furthermore, recently, USB-PD (USB Power Delivery) was established as a standard for USB-Type-C charging and, when combining a USB-PD compatible power feeder, a USB-C cable, and an information communication device such as a notebook computer that supports USB-PD, power up to 100 W or 240 W (USB-PD 3.1) can be supplied.

Therefore, by combining with a USB-PD-compatible power feeder and a USB-C cable, even a relatively large information communication device such as a notebook computer can be used in combination with a USB power feeder that is small and can be plugged directly into a household AC power outlet. However, with a conventional information communication device of the type where power for charging is inputted from DC power input units, it may not be possible to input power for charging from a USB-C cable even if the device is equipped with a USB-C terminal.

For this reason, conversion adapters are available that use a USB-C terminal as an input and a jack shaped to fit the DC power input unit of a specific notebook computer or the like as an output. However, these conversion adapters according to conventional art merely convert a terminal shape, and even if a USB-C cable is connected to the input side, information such as which notebook computer is to be charged by the conversion adapter, what are appropriate input voltage and current of the notebook computer, and the like cannot be provided to the USB power feeder via the USB-C cable.

In view of the problems in using the conversion adapters according to conventional art described above, the power feeder according to one aspect includes a detecting unit that detects a type of a conversion adapter connected to a DC output unit. In addition, by detecting a type of the conversion adapter with the detecting unit, a type of the notebook computer with which a jack of the conversion adapter is compatible can be recognized and information on a required input voltage and/or current of the notebook computer can be acquired.

An AC output unit (power outlet) may be further added to the power feeder. In this case, a reduction in the number of power outlet plugs can be suppressed by connecting the power feeder to the power outlet.

(2)

A power feeder according to a second invention is the power feeder according to the one aspect, wherein when the detecting unit detects a type of the conversion adapter, DC power corresponding to the conversion adapter may be outputted from the DC output unit.

There are several types of input voltages of notebook computers including 16 V, 19 V, and 20 V and, for example, if a 20 V voltage is applied to a 16 V-input notebook computer, an increase in heat generated on the notebook computer may cause a loss of power and possibly lead to being destroyed.

On the other hand, when a 15 V voltage is applied to 20 V-input notebook computers, many of the notebook computers will not charge and a charge icon will not be displayed. However, there are some devices that end up being charged even at 15 V, in which case a maximum current that can flow through the charger is outputted from the charger and heats up the charger, possibly leading to its destruction. Alternatively, the charger may repeat a cycle of “output; stop due to exceeding current value; and output” and may end up being destroyed.

In the power feeder according to the second invention, by detecting a type of the conversion adapter, recognizing a type of a notebook computer with which a jack of the conversion adapter is compatible, and outputting DC power (voltage, current) required by the notebook computer, problems such as inability to charge, high power loss, and in the worst case, destruction can be prevented.

(3)

A power feeder according to a third invention is the power feeder according to the second invention, wherein when the DC output unit is unable to output DC power corresponding to the conversion adapter, power may not be supplied from the DC output unit.

For example, with a power feeder only capable of outputting a maximum voltage of 15 V, when it is recognized based on a type of the conversion adapter that a voltage required by a connected notebook computer is 20 V but the notebook computer is charged even at 15 V, having the power feeder output a voltage of 15 V results in a maximum current that can flow through the power feeder being outputted from the power feeder, causing the power feeder to heat up and possibly be destroyed. Alternatively, the power feeder may repeat a cycle of “output; stop due to exceeding current value; and output” and in the worst case may end up being destroyed.

In order to prevent such a situation from occurring, in the power feeder according to the third invention, power is not supplied from the DC output unit when the power feeder is unable to output a voltage required by a notebook computer to which the conversion adapter is connected.

(4)

A power feeder according to a fourth invention is the power feeder according to any of inventions from the one aspect to the third invention, further including a display unit that displays, when a type of the conversion adapter is detected, the fact that the type of the conversion adapter has been detected.

In this case, by displaying that the type of the conversion adapter has been detected, a user can confirm that a safety function of the power feeder is working and can be provided with a sense of security. In addition, when the power feeder has DC output units of a plurality of systems, the user can readily comprehend that a DC output unit to which the conversion adapter is not connected may have its output power suppressed.

(5)

A power feeder according to a fifth invention is the power feeder according to any of inventions from the one aspect to the fourth invention, wherein the DC output unit and the conversion adapter may be connected via a USB-C cable and a type of the conversion adapter may be detected based on a VID (Vender ID) and a PID (Product ID).

By having both the power feeder and the conversion adapter equipped with USB-C terminals and the DC output unit and the conversion adapter being connected via a USB-C cable, the power feeder can be shared with a USB-PD (Power Delivery)—compatible power feeder. In addition, by setting a VID and a PID to the conversion adapter connected by a USB cable, the VID and the PID can be detected according to standard USB specifications and a type of the conversion adapter and a type of a notebook computer to which the conversion adapter is compatible can be easily identified from the VID and the PID.

(6)

A power feeder according to a sixth invention is the power feeder according to any of inventions from the one aspect to the fifth invention, wherein the power feeder may operate as a USB-PD-compatible power feeder when the DC output unit is directly connected to a personal computer via a USB-C cable. Note that USB-PD stands for USB-Power Delivery.

In the power feeder according to the sixth invention, the DC output unit is constituted of a USB-C terminal and can be directly connected to a personal computer via a USB-C cable.

Therefore, when the power feeder is connected to a USB-PD-compatible notebook computer via a USB-C cable that is USB-PD compatible, the power feeder can be operated as a USB power feeder that is USB-PD compatible.

In this case, it is convenient being able to use a single power feeder for a wide range of applications by feeding power via the conversion adapter to a conventional notebook computer equipped with a DC power input unit and feeding power directly to a recent USB-PD-compatible notebook computer and the like.

(7)

A conversion adapter according to another aspect is a conversion adapter connectable to the power feeder according to any of inventions from the one aspect to the sixth invention and the conversion adapter may include: a DC input unit to be connected to the power feeder; a jack that is shaped to fit a DC power input unit of a specific personal computer and that supplies DC power; a power feeder detecting unit that detects a type of the power feeder; and a protection circuit that stops output of DC power from the jack when the power feeder is unable to supply power required by the specific personal computer.

The conversion adapter according to another aspect can detect a type of a power feeder to be connected and, therefore, the conversion adapter can acquire specifications of DC power that the power feeder can supply. In addition, when the power feeder is unable to supply DC power (voltage, current) required by the personal computer such as when a maximum output voltage of the power feeder is 15 V and the voltage required by the personal computer is 20 V, depending on a type of the personal computer, a maximum current that can flow through the power feeder may be outputted from the power feeder, causing the power feeder to heat up and possibly be destroyed. Alternatively, the power feeder may repeat a cycle of “output; stop due to exceeding current value; and output” and may end up being destroyed. In such a case, the conversion adapter according to another aspect can prevent the worst from happening in advance by stopping the output of DC power from the jack.

While a connection method between the power feeder and the conversion adapter and a detection method by the power feeder detecting unit are not limited, for example, the power feeder and the conversion adapter may be connected with a USB-C cable and a type of the power feeder may be detected by having the conversion adapter detect the VID (Vender ID) and the PID (Product ID) of the power feeder.

(8)

A conversion adapter according to an eighth invention is the conversion adapter according to another aspect, wherein, when the power feeder detecting unit cannot detect a type of the power feeder, output of the power feeder may be outputted as is or the output may be stopped.

Since a type of a personal computer to which the jack of the output unit of the conversion adapter is connected is limited, specifications such as whether the protection circuit of the personal computer will operate when the power feeder is unable to supply the DC power required by the personal computer can be comprehended.

Therefore, for example, the conversion adapter may output the output of the power feeder as-is or stop the output of the power feeder depending on a type of the personal computer to which the conversion adapter is connected.

(9)

A power feeding apparatus according to another aspect includes: the power feeder according to any of inventions from the one aspect to the sixth invention; and the conversion adapter according to the seventh invention or the eighth invention, wherein, when the power feeder and the conversion adapter are connected, DC power corresponding to a specific personal computer with which a jack of the conversion adapter is compatible is outputted, and when the power feeder cannot output DC power corresponding to the specific personal computer, the output is stopped.

In the power feeding apparatus according to the other aspect, information on DC power required by a connected personal computer is determined according to a type of the conversion adapter, and by having the power feeder detect the type of the conversion adapter, the power feeder can recognize information on the DC power required by the connected personal computer.

Therefore, by setting DC output of the power feeder to the DC power required by the connected personal computer, the power feeder according to the other aspect can provide the personal computer with optimal DC power for the personal computer.

In addition, when the power feeder is unable to supply the DC power required by the personal computer, stopping output of the power feeder enables situations such as excessive power loss, destruction of the power feeder or the personal computer, or the like to be prevented in advance.

(10)

A power feeding apparatus according to a tenth invention is the power feeding apparatus according to the other aspect, wherein the power feeder may include the DC output unit of each of two or more systems, and when the conversion adapter is connected to the DC output unit of one system, output power of the power feeder may be preferentially distributed to the DC output unit on the system to which the conversion adapter is connected.

Conventionally, in a power feeder including DC output units of two systems, a distribution of DC power to the DC output units of two systems is fixed. For example, with a power feeder with a maximum output of 70 W, output 1 is often set to 45 W and output 2 is often set to 25 W. In addition, for example, when the DC power required by a personal computer is 65 W, a charger with the fixed distribution of DC power described above is unable to supply the DC power required by the personal computer.

In contrast, with the power feeding apparatus according to the tenth invention, when the conversion adapter is connected to one DC output unit, the power feeder can recognize information on the DC power required by the connected personal computer by detecting the type of the conversion adapter and the required DC power can be preferentially distributed. Specifically, the DC power required by the personal computer or, in other words, 65 W can be distributed to the conversion adapter and the personal computer can be charged with appropriate DC power.

### BRIEF DESCRIPTION OF THE DRAWINGS

FIG. 1 is a schematic configuration diagram of a power feeding apparatus constituted of a power feeder and a conversion adapter.

FIG. 2 is a schematic configuration diagram of a power feeding apparatus constituted of a power feeder including two systems of output and a conversion adapter.

FIG. 3A is a schematic perspective view showing an example of an outer appearance of a power feeder when viewed from a front side and FIG. 3B is a schematic perspective view showing an example of an outer appearance of the power feeder when viewed from a back side.

FIGS. 4A, 4B, 4C, and 4D are, respectively, schematic perspective views showing an example of an outer appearance of a conversion adapter including a jack shaped to fit a DC power input unit of a different personal computer.

FIG. 5 is a schematic flowchart showing an example of an operation flow of a power feeder.

FIG. 6 is a schematic flowchart showing an example of an operation flow of a conversion adapter.

FIG. 7 is a schematic configuration diagram of a modified usage of a power feeder.

FIG. 8 is a schematic configuration diagram of a power feeding apparatus constituted of a power feeder and a conversion adapter according to conventional art.

### DETAILED DESCRIPTION OF THE INVENTION

Hereinafter, an embodiment of the present invention will be described with reference to the drawings. In the following description, same components are assigned the same reference signs. In addition, when components have the same reference signs, names and functions of such components are also the same. Therefore, detailed descriptions of such components will not be repeated.

### [Power Feeding Apparatus 100]

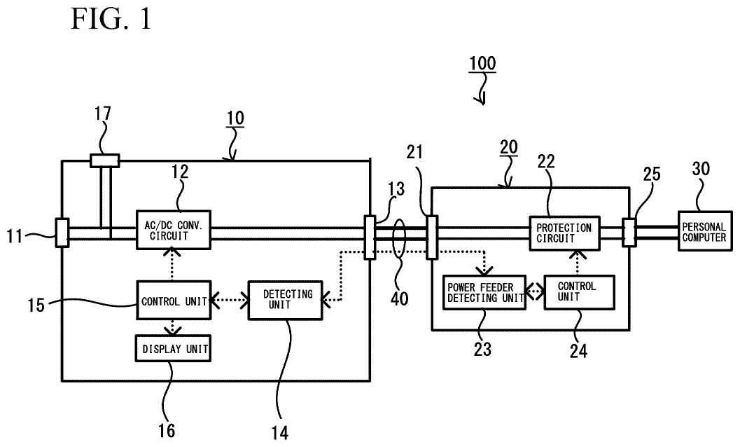

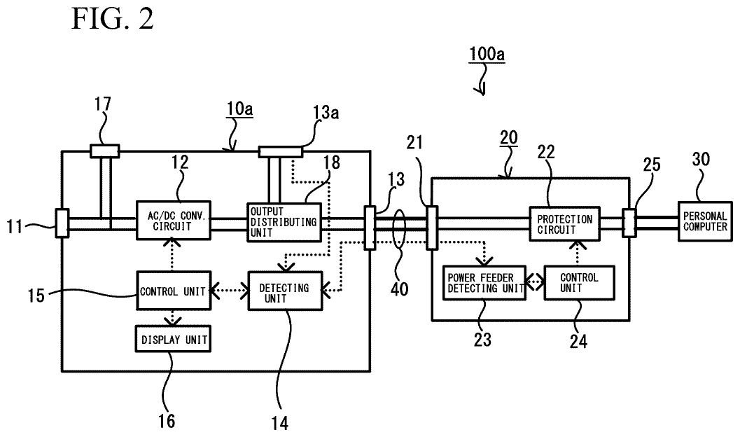

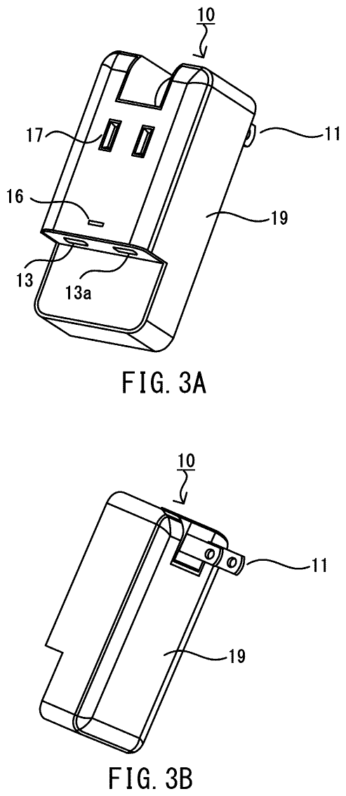

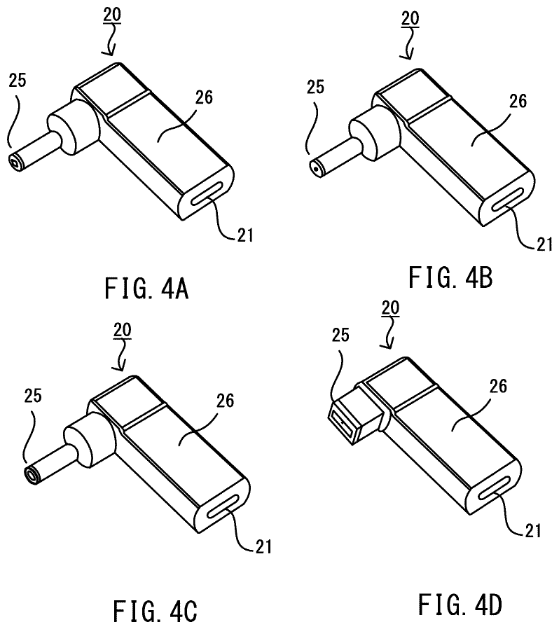

FIG. 1 is a schematic configuration diagram of a power feeding apparatus 100 constituted of a power feeder 10 and a conversion adapter 20. FIG. 2 is a schematic configuration diagram of a power feeding apparatus 100a constituted of a power feeder 10a including two systems of output, and the conversion adapter 20. FIG. 3A and FIG. 3B are schematic perspective views showing examples of an outer appearance of the power feeder 10. And FIGS. 4A, 4B, 4C, and 4D are schematic perspective views of conversion adapters 20 including jacks 25 shaped to fit a DC power input unit of a different notebook computer 30.

In FIG. 1, the power feeder 10 and the conversion adapter 20 are connected by a USB-C cable 40 and an output of the conversion adapter 20 supplies DC power to the specific notebook computer 30 via the jack 25 shaped to fit the DC power input unit of the notebook computer 30.

While the object to which the conversion adapter 20 supplies DC power is described as the notebook computer 30 in the present embodiment, the object to which DC power is supplied is not limited to the notebook computer 30. For example, the power feeding apparatus 100 according to the present invention can supply DC power even to information communication devices such as personal computers other than notebook computers, tablet computers, and the like as long as DC power can be supplied to the devices via the jack 25 with a specific shape.

In addition, while the power feeder 10 and the conversion adapter 20 are connected by the USB-C cable 40 in the present embodiment, the cable connecting the power feeder 10 and conversion adapter 20 need not be the USB-C cable 40 as long as the cable includes a cable that supplies DC power and a signal cable that connects a detecting unit 14 of the power feeder 10 and a power feeder detecting unit 23 of the conversion adapter 20.

The power feeder 10 includes a power plug unit 11, an AC/DC conversion circuit 12, a USB port unit 13, the detecting unit 14, a control unit 15, and a display unit 16. The power feeder 10 may include one or a plurality of power outlet units that are connected to the power plug unit 11 and to which other power plugs can be inserted.

The AC/DC conversion circuit 12 inputs AC power from the power plug unit 11 and outputs DC power of a predetermined voltage and current from the USB port unit 13 upon request from the control unit 15.

The detecting unit 14 is connected to the USB port unit 13 and acquires information such as a VID (Vender ID) and a PID (Product ID) of the conversion adapter 20 via the USB-C cable 40. When the cable connecting the power feeder 10 and the conversion adapter 20 is not the USB-C cable 40, the type of the conversion adapter 20 may be detected by a method other than detecting the VID and the PID.

When the control unit 15 detects information on the conversion adapter 20 to which the detecting unit 14 is connected, the control unit 15 instructs the AC/DC conversion circuit 12 to supply DC power of the required voltage and current based on information such as the detected VID and PID. If the power feeder 10 is unable to supply the required voltage or current, the control unit 15 instructs the AC/DC conversion circuit 12 to stop supplying power.

Alternatively, when information such as the VID and PID cannot be acquired or the VID and PID can be acquired but specifications such as voltage and current corresponding to the VID and PID are unknown, generic DC power (voltage, current) specific to the power feeder 10 is outputted.

When the control unit 15 detects information on the conversion adapter 20, the control unit 15 displays the fact that the information has been detected using an LED of the display unit 16 or the like. Alternatively, a liquid crystal display or the like may be provided in the display unit 16 to display information such as output voltage and current.

The conversion adapter 20 has a USB port unit 21, a protection circuit 22, a power feeder detecting unit 23, a control unit 24, and a jack 25.

The protection circuit 22 is inserted between the USB port unit 21 and the jack 25 and, when necessary, stops supply of DC power from the jack 25. For example, the protection circuit 22 can be constituted of a power FET.

The power feeder detecting unit 23 is connected to the USB port unit 21 and acquires information such as a VID (Vender ID) and a PID (Product ID) of the power feeder 10 via the USB-C cable 40. When the cable connecting the power feeder 10 and the conversion adapter 20 is not the USB-C cable 40, the type of the power feeder 10 may be detected by a method other than detecting the VID and the PID.

When the power feeder detecting unit 23 detects information on the connected power feeder 10, the control unit 24 comprehends the DC power (voltage, current) that can be supplied by the power feeder 10 based on information such as the detected VID and PID, but when the power feeder 10 is unable to supply the required voltage or current, the control unit 24 shuts down the protection circuit 22 to stop the supply of power.

In addition, when information on the power feeder 10 could not be detected, the control unit 24 supplies generic power from the power feeder 10 to the personal computer as-is in accordance with generic output settings of the conversion adapter 20 or stops the supply of power. The generic output settings may be fixed for each personal computer with which the conversion adapter 20 is compatible or may be made switchable by providing the conversion adapter 20 with a changeover switch (not illustrated).

The jack 25 has a different shape for each compatible notebook computer 30 (refer to FIGS. 4A, 4B, 4C, and 4D), and checking to see if the jack 25 fits the DC power input unit of the notebook computer 30 ensures that the conversion adapter 20 is the conversion adapter 20 that is compatible with the notebook computer 30.

FIG. 2 is a schematic configuration diagram of a power feeding apparatus 100a constituted of a power feeder 10a including two systems of output, and the conversion adapter 20. In contrast to the configuration diagram in FIG. 1, the configuration diagram in FIG. 2 shows an additional output distributing unit 18 that distributes the output of the AC/DC conversion circuit 12, and a second-system USB port unit 13a. Since other components are the same as those of the power feeding apparatus 100 shown in FIG. 1, descriptions thereof will not be repeated.

In normal use, the power feeder 10a with two systems of output distributes the output power of the AC/DC conversion circuit 12 at a fixed ratio. For example, when a maximum capability of the power feeder 10a is 70 W, the USB port unit 13 is 45 W and the USB port unit 13a is 25 W in normal use.

However, with the power feeding apparatus 100a according to the present invention, when the conversion adapter 20 is connected to the USB port unit 13 via the USB-C cable 40, distribution of power to the USB port unit 13 to which the conversion adapter 20 is connected is prioritized. For example, when the power feeder 10a detects the connection of the conversion adapter 20 and determines that the notebook computer 30 to which the conversion adapter 20 supplies DC power requires 65 W of power, the output distributing unit 18 changes a distribution ratio of power so that 65 W of power is distributed to the USB port unit 13 and 5 W of power is distributed to the USB port unit 13a.

Accordingly, with the power feeding apparatus 100a of the present invention, a shortage of power supplied to the notebook computer 30 (a state where a charge icon is not displayed) that occurs when a conversion adapter 20b according to conventional art is connected to the power feeder 10a (maximum output of 70 W) with two systems of output can be avoided.

While FIG. 2 shows a configuration diagram of the power feeder 10a including two systems of output, three or more systems of output may be provided when necessary. In this case, all of the systems may adopt the USB-C standard or there may be a mixture of a plurality of standards such as some systems adopting the USB-C standard and others adopting the USB-A standard.

In addition, the output distribution of the output distributing unit 18 is not limited to the example described above and, for example, depending on the detected type of the conversion adapter 20, the power distribution ratio between the USB port unit 13 to which the conversion adapter 20 is connected and the other USB port unit 13a may be changed when appropriate to a preset ratio.

### [Outer Appearance of Power Feeder 10a and Conversion Adapter 20]

FIG. 3A is a schematic perspective view showing an example of an outer appearance of the power feeder 10a when viewed from a front side and FIG. 3B is a schematic perspective view showing an example of an outer appearance of the power feeder 10a when viewed from a back side.

To use the power feeder 10a, a housing 19 is grasped, the power plug unit 11 is inserted into a power outlet (not illustrated), and the USB-C cable 40 is inserted into the USB port unit 13. In addition, a plug of another electric device may be inserted into a power outlet unit 17 when necessary.

Providing a stepped portion in the housing 19 and providing the USB port unit 13 in the stepped portion preferably protects a connector unit of the USB-C cable 40. Furthermore, it is convenient if the power plug unit 11 is rotatably fixed to the housing 19.

FIGS. 4A, 4B, 4C, and 4D each shows an example of an outer appearance of the conversion adapter 20 including the jack 25 shaped to fit a DC power input unit of a different personal computer.

To use the conversion adapter 20, the USB-C cable 40 is inserted into the USB port unit 21 with the opposite end being connected to the power feeder 10 or 10a, and the jack 25 is inserted into the compatible notebook computer 30. The DC power input unit of the notebook computer 30 has a different shape for each manufacturer or model of the notebook computer 30, and by checking whether the jack 25 fits the DC power input unit of the personal computer, the conversion adapter 20 is ensured to be the conversion adapter 20 that is compatible with the notebook computer 30.

### [Operation Flow of Power Feeder 10 and Conversion Adapter 20]

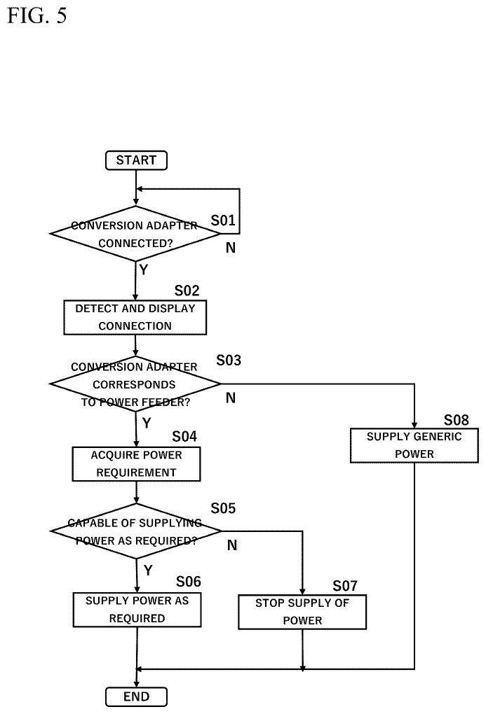

FIG. 5 shows a flowchart of an operation flow of the power feeder 10.

Hereinafter, the operation flow of the power feeder 10 will be described based on FIG. 5.

### (Step S01)

Stand by until the conversion adapter 20 is connected.

### (Step S02)

When the conversion adapter 20 is connected, display the connection on the display unit 16 (such as an LED).

### (Step S03)

Acquire the VID and PID of the conversion adapter 20 through the USB-C cable 40 to check whether the conversion adapter 20 is the conversion adapter 20 corresponding to the power feeder 10 according to the present invention.

### (Step S04)

When the conversion adapter 20 is the conversion adapter 20 corresponding to the power feeder 10 according to the present invention, acquire a power requirement of the notebook computer 30 to which power is fed from the conversion adapter 20. When the conversion adapter 20 is the conversion adapter 20 corresponding to the power feeder 10 according to the present invention, the power requirement can be acquired by acquiring a VID and a PID.

### (Step S05)

Check if the power feeder 10 is capable of supplying DC power as per the power requirement of the notebook computer 30.

### (Step S06)

When the power feeder 10 is capable of supplying power as per the power requirement of the notebook computer 30, supply DC power as per the power requirement.

### (Step S07)

When the power feeder 10 is not capable of supplying power as per the power requirement of the notebook computer 30, do not supply power.

### (Step S08)

When the conversion adapter 20 is not the conversion adapter 20 corresponding to the power feeder 10 of the present invention, output generic power (voltage, current) specific to the power feeder 10.

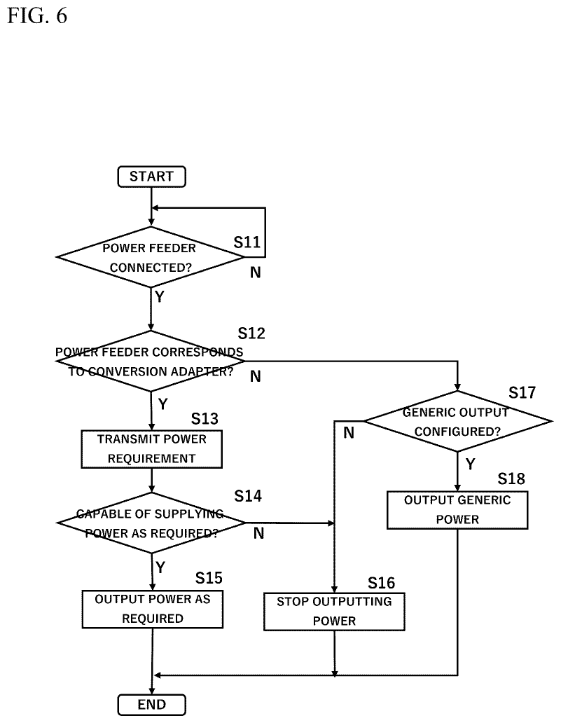

FIG. 6 shows a flowchart of an operation flow of the conversion adapter 20.

Hereinafter, the operation flow of the conversion adapter 20 will be described based on FIG. 6.

### (Step S11)

Stand by until the power feeder 10 is connected.

### (Step S12)

Acquire the VID and PID of the power feeder 10 through the USB-C cable 40 to check whether the power feeder 10 is the power feeder 10 corresponding to the conversion adapter 20 according to the present invention.

### (Step S13)

When the power feeder 10 is the power feeder 10 corresponding to the conversion adapter 20 according to the present invention, transmit the power requirement of the notebook computer 30 connected to the conversion adapter 20 through the USB-C cable 40. When the power feeder 10 is the power feeder 10 corresponding to the conversion adapter 20 according to the present invention, the power requirement can be transmitted by transmitting the VID and the PID of the conversion adapter 20.

### (Step S14)

Check if the power feeder 10 is capable of supplying power as per the power requirement of the notebook computer 30. When the power feeder 10 is the power feeder 10 corresponding to the conversion adapter 20 according to the present invention, a power supply capability of the power feeder 10 can be acquired by acquiring the VID and the PID of the power feeder 10.

### (Step S15)

When the power feeder 10 is capable of supplying power as per the power requirement of the notebook computer 30, output DC power as per the requirement.

### (Step S16)

When the power feeder 10 is not capable of supplying power as per the power requirement of the notebook computer 30, stop output of DC power. Specifically, shut down a switch constituted of a FET of the protection circuit 22 or the like.

### (Step S17)

When the power feeder 10 is not the power feeder 10 corresponding to the conversion adapter 20 according to the present invention, check whether the conversion adapter 20 is configured to output generic power. Whether the conversion adapter 20 outputs generic power is determined for each conversion adapter 20 based on specifications of a protection circuit of the corresponding notebook computer 30 or the like. For example, when a problem such as a large amount of heat generated by the power feeder 10 and/or the corresponding notebook computer 30 is anticipated when a non-standard voltage or current is supplied to the notebook computer 30, the conversion adapter 20 corresponding to the notebook computer 30 is configured not to output generic power.

### (Step S18)

When the conversion adapter 20 is configured to output generic power, have the conversion adapter 20 supply the generic power supplied from the power feeder 10 to the notebook computer 30 as-is. When the conversion adapter 20 is configured not to output generic power, stop output of DC power. Specifically, shut down a switch constituted of a FET of the protection circuit 22 or the like (step S16).

### [Modification of Usage of Power Feeder 10]

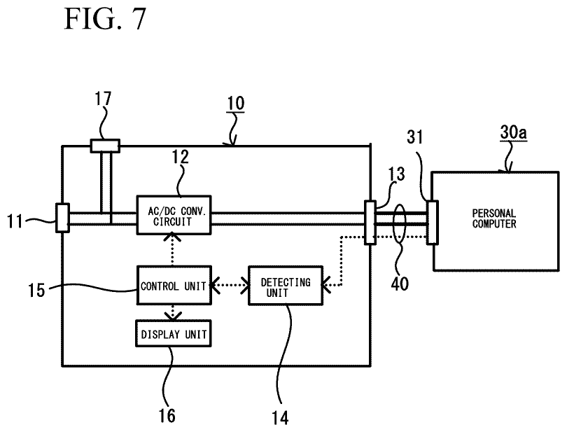

FIG. 7 is a schematic configuration diagram in a case where the power feeder 10 is directly connected to a notebook computer 30a that includes a USB port unit 31 and is USB-PD compliant.

In this case, the USB port unit 13 of the power feeder 10 is connected to the USB port unit 31 of the notebook computer 30a via the USB-C cable 40.

In addition, the power feeder 10 in this case operates according to standard specifications for USB-PD-compatible power feeders. Therefore, a description of the operation of the power feeder 10 will be omitted.

### [Configuration Example of Power Feeding Apparatus 100b Constituted of Power Feeder 10b and Conversion Adapter 20b According to Conventional Art]

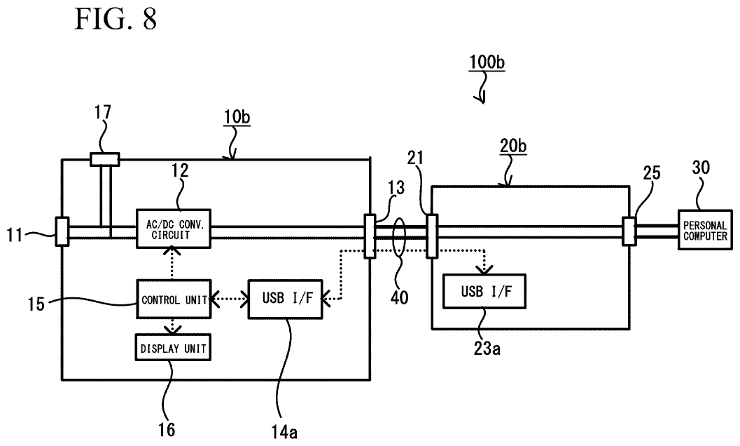

FIG. 8 shows a configuration diagram of a power feeding apparatus 100b constituted of a power feeder 10b and a conversion adapter 20b according to conventional art.

Even in this case, the power feeder 10b and the conversion adapter 20b are connected via the USB-C cable 40. Therefore, a USB I/F 14a of the power feeder 10b and a USB I/F 23a of the conversion adapter 20b can acquire VIDs and PIDs of the connected power feeder 10b and conversion adapter 20b. However, the power feeding apparatus 100b constituted of the power feeder 10b and the conversion adapter 20b according to conventional art has the following problems.
(a) Even if the power feeder 10b acquires the VID and the PID of the conversion adapter 20b, the power requirement of the notebook computer 30 to which the conversion adapter 20b feeds power cannot be acquired.
(b) Even if the conversion adapter 20b acquires the VID and the PID of the power feeder 10b, whether or not the power feeder 10b is capable of supplying DC power as per the power requirement of the notebook computer 30 cannot be checked.

Therefore, with the power feeding apparatus 100b constituted of the power feeder 10b and the conversion adapter 20b according to conventional art, the power feeder 10b is not capable of supplying DC power as per the power requirement of the notebook computer 30. In addition, even when the power feeder 10 is not capable of supplying power as per the power requirement of the notebook computer 30, the supply of power cannot be stopped.

Furthermore, comparing the conversion adapter 20 according to the present invention with the conversion adapter 20b according to conventional art, the difference is that the conversion adapter 20 according to the present invention has the protection circuit 22 inserted between input and output of DC power of the conversion adapter 20 while the conversion adapter 20 according to conventional art does not have the protection circuit 22.

In addition, while the conversion adapter 20 according to the present invention can shut off supply of DC power of the conversion adapter 20 if a problem such as high heat generation from the power feeder 10 and/or the notebook computer 30 to which the conversion adapter 20 feeds power is anticipated when a non-standard voltage or current is supplied to the notebook computer 30, with the power feeding apparatus 100b constituted of the power feeder 10b and the conversion adapter 20b according to conventional art, the supply of DC power of the conversion adapter 20b cannot be shut off.

As described above, the power feeding apparatus 100 constituted of the power feeder 10 and the conversion adapter 20 according to the present invention has the following advantageous effects:
(A) by connecting the conversion adapter 20 including the jack 25 shaped to fit the DC power input unit of the specific notebook computer 30 to the power feeder 10, DC power required by the specific notebook computer 30 can be supplied;
(B) when the power feeder 10 is unable to supply the DC power required by the specific notebook computer 30, the supply of the DC power can be stopped and unstable operations due to supplying non-standard power including problems such as high heat generation from the power feeder 10 and/or the notebook computer 30 can be prevented; and
(C) even when the conversion adapter 20 is connected to the power feeder 10b according to conventional art, when unstable operations due to supplying non-standard power is anticipated, supply of DC power to the notebook computer 30 can be stopped by the protection circuit 22 of the conversion adapter 20.

In the present invention, the power plug unit 11 corresponds to the “power plug unit”, the AC/DC conversion circuit 12 corresponds to the “AC/DC conversion circuit”, the USB port units 13 and 13a correspond to the “DC output unit”, the notebook computer 30 corresponds to the “personal computer”, the jack 25 corresponds to the “jack”, the conversion adapter 20 corresponds to the “conversion adapter”, the detecting unit 14 corresponds to the “detecting unit”, the power feeders 10 and 10a correspond to the “power feeder”, the display unit 16 corresponds to the “display unit”, the USB-C cable 40 corresponds to the “USB-C cable”, the USB port unit 21 corresponds to the “DC input unit”, the power feeder detecting unit 23 corresponds to the “power feeder detecting unit”, the protection circuit 22 corresponds to the “protection circuit”, and the power feeding apparatus 100 corresponds to the “power feeding apparatus”.

While a preferable embodiment of the present invention is as described above, the present invention is not limited thereto. It should be understood that various other embodiments may be made without deviating from the spirit and the scope of the present invention. Furthermore, while operations and effects due to the configuration of the present invention have been described in the present embodiment, the operations and effects are merely examples and are not intended to limit the present invention.

### REFERENCE SIGNS LIST

10, 10a, 10b power feeder
11 power plug unit
12 AC/DC conversion circuit
13, 13a, 21, 31 USB port unit
14 detecting unit (USB I/F)
16 display unit
20, 20b conversion adapter
22 protection circuit
23 power feeder detecting unit (USB I/F)
25 jack
30, 30a notebook computer
40 USB-C cable
100, 100a, 100b power feeding apparatus

1. A power feeder, comprising:
a power plug unit to which AC power is inputted;
an AC/DC conversion circuit that converts AC power into DC power;
a DC output unit that outputs the converted power; and
a detecting unit that detects, when a conversion adapter equipped with a jack shaped to fit a DC power input unit of a specific personal computer is connected to the DC output unit, a type of the conversion adapter.

2. The power feeder according to claim 1, wherein when the detecting unit detects a type of the conversion adapter, DC power corresponding to the conversion adapter is outputted from the DC output unit.

3. The power feeder according to claim 2, wherein when the DC output unit is unable to output DC power corresponding to the conversion adapter, power is not supplied from the DC output unit.

4. The power feeder according to claim 1, further comprising a display unit that displays, when a type of the conversion adapter is detected, the fact that the type of the conversion adapter has been detected.

5. The power feeder according to claim 1, wherein the DC output unit and the conversion adapter are connected via a USB-C cable and a type of the conversion adapter is detected based on a VID (Vender ID) and a PID (Product ID).

6. The power feeder according to claim 1, wherein the power feeder operates as a USB-PD-compatible power feeder when the DC output unit is directly connected to a personal computer via a USB-C cable.

7. A conversion adapter connectable to the power feeder according to claim 1, the conversion adapter comprising:
a DC input unit to be connected to the power feeder;
the jack that is shaped to fit the DC power input unit of the specific personal computer and that supplies DC power;
a power feeder detecting unit that detects a type of the power feeder; and
a protection circuit that stops output of DC power from the jack when the power feeder is unable to supply power required by the specific personal computer.

8. The conversion adapter according to claim 7, wherein, when the power feeder detecting unit cannot detect a type of the power feeder, output of the power feeder is outputted as is or the output is stopped.

9. A power feeding apparatus, comprising:
a power feeder, comprising:
a power plug unit to which AC power is inputted;
an AC/DC conversion circuit that converts AC power into DC power;
a DC output unit that outputs the converted power; and
a detecting unit that detects, when a conversion adapter equipped with a jack shaped to fit a DC power input unit of a specific personal computer is connected to the DC output unit, a type of the conversion adapter; and
the conversion adapter according to claim 7, wherein
when the power feeder and the conversion adapter are connected, DC power corresponding to the specific personal computer with which the jack of the conversion adapter is compatible is outputted, and
when the power feeder cannot output DC power corresponding to the specific personal computer, the output is stopped.

10. The power feeding apparatus according to claim 9, wherein the power feeder includes the DC output unit of each of two or more systems, and when the conversion adapter is connected to the DC output unit of one system, output power of the power feeder is preferentially distributed to the DC output unit on the system to which the conversion adapter is connected.
